(19) United States
(12) Patent Application Publication
(10) Pub. No.: US 2004/0223079 A1
(43) Pub. Date: Nov. 11, 2004

(54) Image recording apparatus

(76) Inventor: Yoshinobu Shibayama, Kanagawa (JP)

Correspondence Address: COWAN LIEBOWITZ & LATMAN P.C, JOHN J TORRENTE, 1133 AVE OF THE AMERICAS, 1133 AVE OF THE AMERICAS, NEW YORK, NY, 10017, US

(21) Appl. No.: 10/774,112

(22) Filed: Feb. 6, 2004

(30) Foreign Application Priority Data
Feb. 12, 2003 (JP) 2003-033785

(51) Int. Cl. H04N 5/225

(52) U.S. Cl. 348/375; 348/231.99

(57) ABSTRACT

A camera having a main body housing and a display housing. The display housing of a display unit is rotatively supported by a shaft of the camera to be movably remote from or near to the main body housing, and is capable of changing the direction of an image display plane. The disk driving mechanism and a circuit board having a control circuit for an image pickup device are disposed in different housings.

### BACKGROUND OF THE INVENTION

1. Field of the Invention

The present invention relates to an image recording apparatus using a disk-like recording medium.

2. Related Background Art

An image pickup apparatus, which picks up a moving image and a still image and records them on a recording imaging medium such as a magneto optical disk and an optical disk, is constituted of an imaging medium driving mechanism, an image pickup element, a photographing lens and the like and is electrically controlled by a control circuit for controlling these components.

Magneto optical disks of the type that utilizes a so-called thermal effect in which a laser beam or the like is irradiated to heat a data write region of the disk to a high temperature, thereby writing data, have come into wide use.

A magneto optical disk driving mechanism of, for example, an imaging apparatus (hereinafter called a camera) for photographing a moving image and recording it on a magneto optical disk, has a dust protective structure because dust attached on the surface of a magneto optical disk may erroneous detection of image data. The inside of the dust protective structure is therefore likely to accumulate heat. In addition, since a control circuit board which may be a heat generating source is disposed near the magneto optical disk mechanism, the inside of the structure is likely to be raised to a high temperature. In the case of a magneto optical disk of the above-described so-called thermal effect type that a laser beam or the like is irradiated to heat a data write region of the disk to a high temperature, the laser beam write conditions may change minutely due to the high temperature of the disk itself, resulting in recording an image incorrectly. In order to avoid a temperature rise, it has been required to additionally use a heat radiating plate, broaden the inner space or use a cooling fan to forcibly flow the inner air.

However, with such a conventional countermeasure, an additional heat radiating plate increases the cost. The space of the heat radiating plate is also necessary to dispose it efficient for radiating the heat of the magneto optical disk driving mechanism having the dust protective structure, resulting in a large size of a camera.

In order to suppress a temperature rise, the inner space is broadened and a cooling fan is used to forcibly flow the inner air. To this end, the space sufficient for forcible air flow is necessary, assembly of the cooling fan makes the size of a camera large, and the cost rises.

### SUMMARY OF THE INVENTION

The present invention has been made in order to solve the above-described problems, and aims to make compact the size of a camera while suppressing transfer of heat generated in an electric control circuit to a disk driving mechanism.

The present invention relates also to prevention of a data read/write error caused by heat generated in a recording apparatus, particularly to suppression of a heat rise in a disk driving mechanism, caused by heat generated in an electric circuit mounted in an imaging apparatus using a disk as its recording medium.

In order to achieve the above-described objects, according to an aspect of the present invention, a camera of the present invention is arranged so that one of a disk driving mechanism for driving an imaging medium and a circuit board mounting a control circuit for controlling the disk driving mechanism, image pickup device and the like is disposed in a display housing of an image display unit using a liquid crystal panel or the like, the display housing being mounted movably remote from and near to a camera main body housing, thereby changing the direction of the image display plane, and the other is disposed in the camera main body housing. According to the camera of the present invention, heat generated in the circuit board mounted with the control circuit for an image pickup device and the like will not be transferred directly to the disk driving mechanism during photographing (particularly continuous photographing). It is therefore possible to provide a camera capable of preventing a temperature rise of the disk driving mechanism.

Other objects and features of the present invention will become apparent from the following description taken in conjunction with the accompanying drawings.

### BRIEF DESCRIPTION OF THE DRAWINGS

FIG. 1 is a schematic cross sectional view of a camera according to a first embodiment of the invention, as viewed along a direction perpendicular to the lens optical axis.

FIG. 2 is a horizontal cross sectional view of the camera of the first embodiment when a display housing is rotated about a shaft relative to the camera main body.

FIG. 3 is a perspective view of the camera of the first embodiment.

FIG. 4 is a perspective view of the camera of the first embodiment when the display housing is rotated.

FIG. 5 is a block diagram showing the outline structure of the camera according to the first embodiment.

FIG. 6 is a schematic cross sectional view of a camera according to a second first embodiment of the invention, as viewed along a direction perpendicular to the lens optical axis.

FIG. 7 is a horizontal cross sectional view of the camera of the second embodiment when a display housing is rotated about a shaft relative to the camera main body.

### DESCRIPTION OF THE PREFERRED EMBODIMENTS

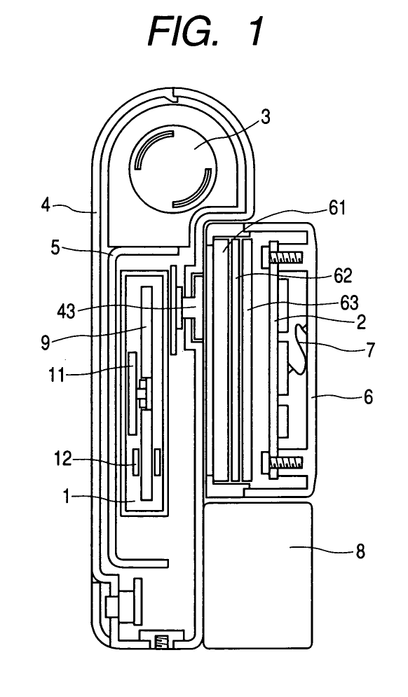

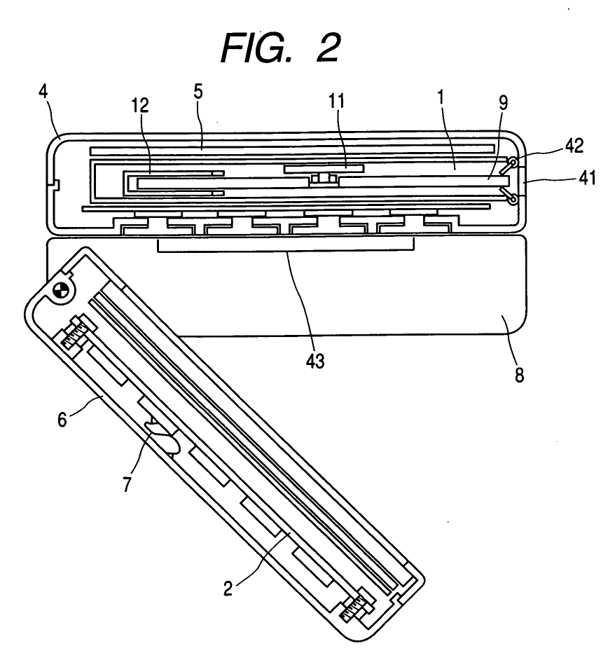

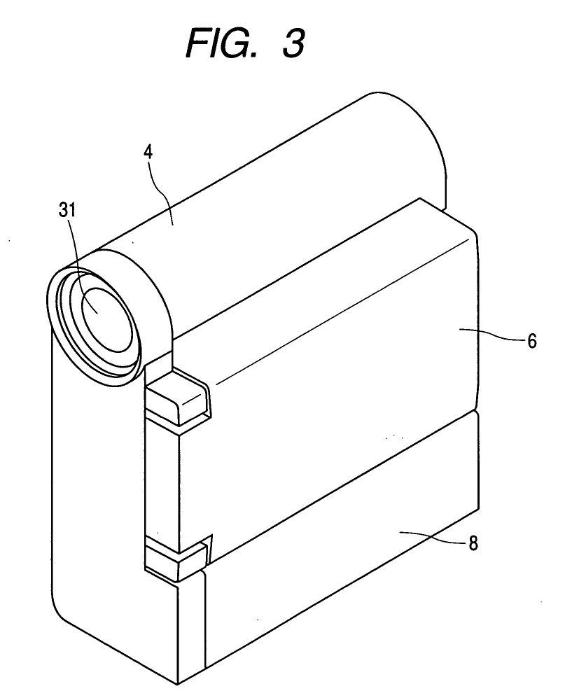

FIGS. 1 to 5 show a camera according to the first embodiment of the invention. FIG. 1 is a schematic cross sectional view of a camera according to a first embodiment of the invention, as viewed along a direction perpendicular to the lens optical axis, FIG. 2 is a horizontal cross sectional view of the camera of the first embodiment when a display housing is rotated about a shaft relative to the camera main body, and FIG. 3 is a perspective view of the camera of the first embodiment.

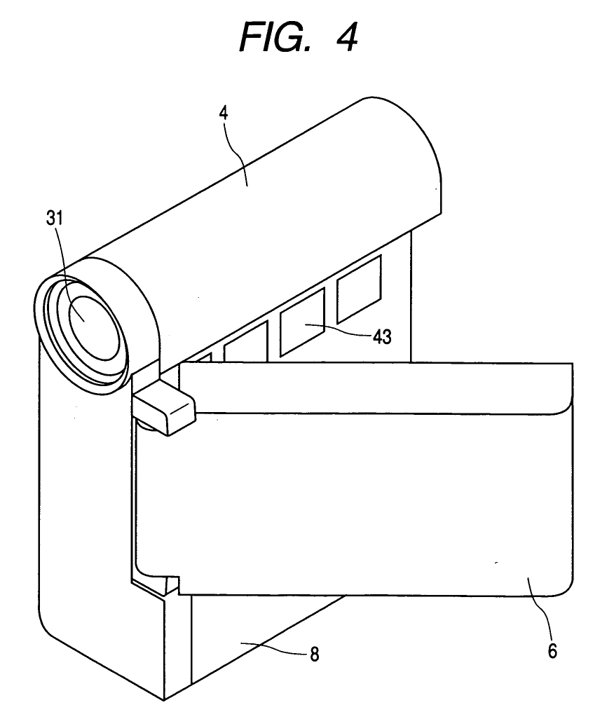

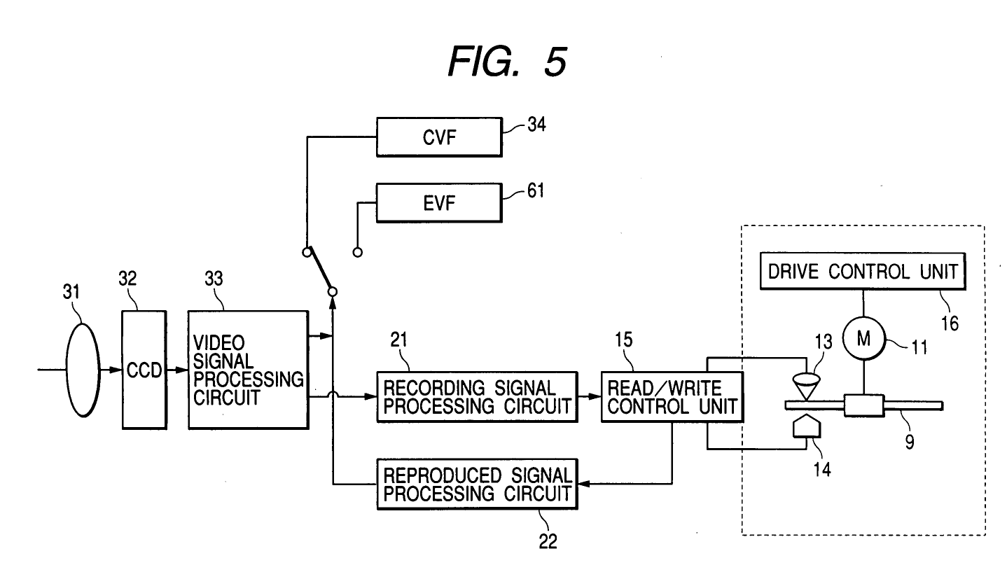

FIG. 4 is a perspective view of the camera of the first embodiment when the display housing is rotated, and FIG. 5 is a block diagram showing the outline structure of the camera according to the first embodiment. Referring to FIG. 1, a magneto optical disk driving mechanism 1 has a dust protective structure of almost a hermetically sealed type in order to prevent an image read/write error caused by dust attached on the surface of a magneto optical disk 9.

When the magneto optical disk 9 is loaded, a driver motor 11 is coupled as its driving source.

A magneto optical head support frame 12 is guided to scan along a line interconnecting the outer periphery and center of the magneto optical disk 9. The magneto optical head support frame 12 has a light emission unit 13 and a magnetic head unit 14, arranged sandwiching the magneto optical disk 9 to be used for image data read/write.

The magneto optical disk driving mechanism 1 has also an image data read/write control unit 15 and an magneto optical disk drive control unit 16. Reference numeral 2 denotes a circuit board having a control circuit for controlling an image pickup device, the magneto optical disk driving mechanism and the like. The circuit board 2 is mainly constituted of a recording signal processing circuit 21, a reproducing signal processing circuit 21, a reproduced signal processing circuit 22 and the like which form a heat generating source. A lens unit 3 for photographing an image of an object is constituted of a photographing lens 31 to be directed toward the object, a CCD disposed at a focussing plane of the photographing lens for converting a focussed image into electric signals, and a video signal processing circuit 33 for processing electric signals output from CCD 32.

The lens unit 3 has also an eyepiece view finder 34. A main body housing 4 accommodates therein the lens unit 3 and magneto optical disk driving mechanism 1. A slit 4i is formed through the back plate of the main body housing 4 on the remote side from an object to be photographed, the magneto optical disk 9 being inserted through this slit 41. In the state that the magneto optical disk 9 is not loaded, protective covers 42 close the slit 41, the protective covers being energized by springs (not shown).

As the magneto optical disk 9 is inserted through the slit 41 formed through the back plate of the main body housing, the protective covers 42 are retracted into the inside of the main body housing 4 and the disk 9 is loaded in the magneto optical disk driving mechanism 1. A fixing holder 5 holds the lens unit 3 and magneto optical disk driving mechanism 1 in the main body housing. A display housing 6 mounted movably remote from and near to the main body housing 4 has therein an image display monitor LCD 61, a back light 62, an LCD driver circuit board 63 and the circuit board 2. An operation button 43 is disposed on the main body housing 4 on the side where the display housing 6 contacts. The operation button 43 is used for performing a process of reproducing a photographed image onto the magneto optical disk 9. A thermal conductive member 7 radiates heat generated in the heat generating sources of the circuit board 2 to the display housing 1. A battery 8 supplies an electric power to drive the image pickup apparatus.

With the structure described above, the magneto optical disk 9 is loaded from the back side of the camera main body housing 4. The inserted magneto optical disk 9 is coupled to the driver motor 11 in the magneto optical disk driving mechanism 9 by a magneto optical disk loading mechanism (not shown).

When an electric power switch (not shown) is turned on or a photographing start switch (not shown) is turned on, an image of an object entered the photographing lens 31 is focussed on CCD 32 and converted into electric signals. The electric signals are displayed as an image on one of the eyepiece view finder 34 and monitor LCD 61 by the video signal processing circuit 33.

Which one of the display means is used for displaying an image is determined by detecting an open/close state of the display housing 6. When the photographing start switch is turned on, the converted electric signals are also supplied to the video signal processing circuit 21, and the magneto optical disk drive control unit 16 and driver motor. 11 make the magneto optical disk 9 rotate. The image data read/write control unit 15 makes the magneto optical head support frame 12 scan the magneto optical disk 9 in a non-contact manner. As light is irradiated, the magneto optical disk 9 is heated to a high temperature so that image data is written by the thermal effect. As this photographing operation is performed continuously, the components on the circuit board 2 generate heat and raise the ambient temperature. Since the magneto optical disk driving mechanism 1 is fixed in the main body housing 4, heat radiated from the circuit board 2 in the display housing 6 will not raise greatly the ambient temperature of the magneto optical disk driving mechanism 1.

Some of the generated heat is transferred to the inner wall of the display housing 6 via the thermal conductive member 7 and radiated externally from the broad outer surface of the display housing 6. Since the circuit board 2 is mounted facing the inner wall of the display housing having a broad heat radiation area, the layout and size of the thermal conductive member 7 and the number of thermal conductive members 7 can be determined at a high degree of freedom.

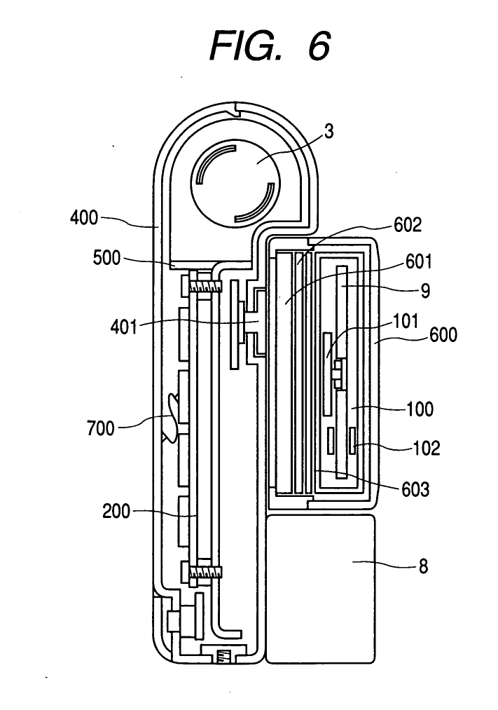

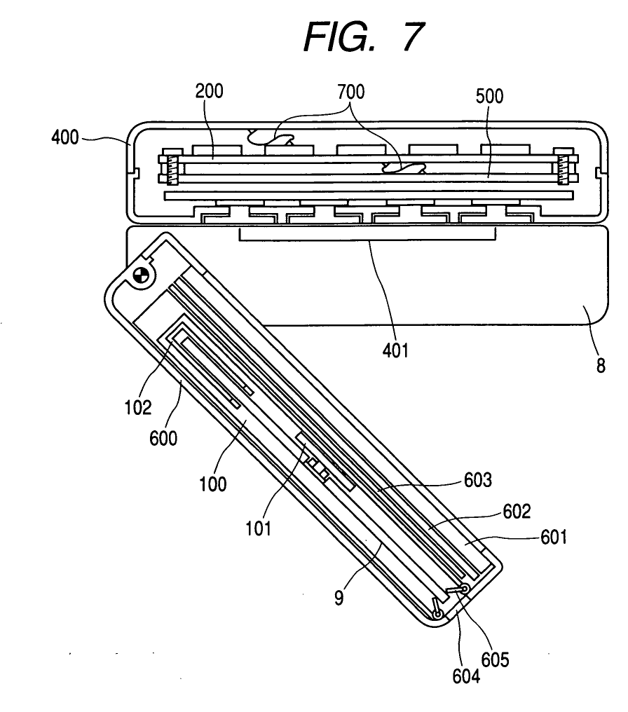

FIGS. 6 and 7 show a camera according to the second embodiment of the invention. FIG. 6 is a schematic cross sectional view of a camera according to a second first embodiment of the invention, as viewed along a direction perpendicular to the lens optical axis, and FIG. 7 is a horizontal cross sectional view of the camera of the second embodiment when a display housing is rotated about a shaft relative to the camera main body. Of the constituent components and units of the second embodiment, those components and units similar to those of the first embodiment are denoted by same reference numerals and the description thereof follows that of the first embodiment. Similar components and units are the structural elements of the magneto optical disk driving mechanism 1, lens unit 3, battery 8, magneto optical disk 9, and structural elements in the block diagram of FIG. 5 showing the outline structure of the camera of the first embodiment.

In FIGS. 6 and 7, a magneto optical disk driving mechanism 100 has a dust protective structure of almost a hermetically sealed type. Reference numeral 200 denotes a circuit board having a control circuit for controlling an image pickup device and the like. A main body housing 400 accommodates therein a lens unit 3 and the circuit board 200. A fixing holder 500 fixes the lens unit 3 and circuit board 200 in the main body housing 400.

A display housing 600 is mounted movably remote from and near to the main body housing 400 and has therein a monitor LCD 601 for displaying an image, a back light 602, an LCD driver circuit board 603 and the magneto optical disk driving mechanism 100. When the monitor LCD 601 is not used, the display housing 600 is closed. A slit 604 is formed through the back plate of the display hosing 600 on the remote side from an object to be photographed. In the state that the magneto optical disk 9 is not loaded, protective covers 605 close the slit 604, the protective covers being energized by springs (not shown). As the magneto optical disk 9 is inserted through the slit 604 formed through the back plate of the display housing 600, the protective covers 605 are retracted into the inside of the display housing 600 and the disk 9 is loaded in the magneto optical disk driving mechanism 100.

An operation button 401 is disposed on the main body housing 400 on the side where the display housing 600 contacts. The operation button 401 is used for performing a process of reproducing a photographed image onto the magneto optical disk 9. A thermal conductive member 700 transfers heat generated in the heat generating sources of the circuit board 200 to the fixing holder 500 or main body housing 100.

With the structure described above, the magneto optical disk 9 is loaded from the back side of the camera display housing 600. The inserted magneto optical disk 9 is coupled to the driver motor 11 in the magneto optical disk driving mechanism 100 by a magneto optical disk loading mechanism (not shown). When an electric power switch (not shown) is turned on or a photographing start switch (not shown) is turned on, an image of an object entered the photographing lens 31 is focussed on CCD 32 and converted into electric signals. The electric signals are displayed as an image on one of the eyepiece view finder 34 and monitor LCD 601 by the video signal processing circuit 33. Which one of the display means is used for displaying an image is determined by detecting an open/close state of the display housing 600. When the photographing start switch is turned on, the converted electric signals are also supplied to the video signal processing circuit 21, and the magneto optical disk drive control unit 16 and driver motor 11 make the magneto optical disk 9 rotate. The image data read/write control unit 15 makes the magneto optical head support frame 12 scan the magneto optical disk 9 in a non-contact manner. As light is irradiated, the magneto optical disk 9 is heated to a high temperature so that image data is written by the thermal effect.

As this photographing operation is performed continuously, the components on the circuit board 200 generate heat and raise the ambient temperature. Since the magneto optical disk driving mechanism 100 is fixed in the display housing 600, heat radiated from the circuit board 200 in the main body housing 400 will not raise greatly the ambient temperature of the magneto optical disk driving mechanism 100. Some of the generated heat is transferred to the inner walls of the fixing holder 500 and main body housing 400 via the thermal conductive member 700 and radiated externally from the surface of the fixing holder and the broad outer surface of the main body housing 400.

Since the circuit board 200 is sandwiched between the fixing holder 500 and main body housing 400 having a broad heat radiation area, the layout and size of the thermal conductive member 700 and the number of thermal conductive members 700 can be determined at a high degree of freedom.

In this embodiment, although the magneto optical disk 9 is used as the recording medium and the image data photographed with the camera is used, the recording medium is not limited to a magneto optical disk, but other recording media for writing data by heating the media to a high temperature may also be used. The data to be recorded is not limited only to image data. For example, it is possible to use a combination of an input means such as a keyboard and a display means for displaying the input data.

As described above, according to the embodiments of the present invention, in a recording apparatus for recording data on a recording medium such as a magneto optical disk which records data by utilizing the thermal effect, and for displaying the data, for example, a camera for photographing a moving image and a still image, one of the disk driving mechanism and the circuit board mounting a control circuit for controlling the disk driving mechanism, image pickup device and the like is disposed in the display housing. The display housing is mounted movably remote from and near to the camera main body housing, rotatively supported and rotated to change the direction of the image display plane. The other is disposed in the camera main body housing. Since the disk driving mechanism and circuit board are mounted in different housings, heat generated in the circuit board will not be transferred directly to the disk driving mechanism during photographing (particularly continuous photographing). It is therefore possible to prevent a temperature rise of the disk driving mechanism and eliminate a write error of image data on the disk caused by heat around the disk.

Since some of generated heat is transferred from a broad area via the thermal conductive member, heat radiation is efficient. Since the circuit board faces the display housing having a broad heat radiation area or is sandwiched between the fixing holder and main body housing, the layout of the thermal conductive member can be determined at a high degree of freedom, and the heat radiation is efficient. Since the heat radiation effect is good, the size and the number of thermal conductive members can be reduced, resulting in a low cost.

Although a magneto optical disk is used as the imaging medium, any recording medium of a disk type may be used. Since the disk is thin, the magneto optical disk driving mechanism can be made thin. Even if the magneto optical disk driving mechanism is disposed in the display housing mounted movably remote from and near to the camera main body housing, the display housing will not become bulky and thick.

Many widely different embodiments of the present invention may be constructed without departing from the spirit and scope of the present invention. It should be understood that the present invention is not limited to the specific embodiments described in the specification, except as defined in the appended claims.

What is claimed is:

1. An image recording apparatus comprising:
a signal processing unit for processing an image signal;
a recording unit for recording data by heating a recording medium;
a display unit for displaying the image signal; and
a connection unit for rotatively connecting a first housing and a second housing,
wherein said signal processing unit and said recording unit are disposed in different housings.

2. An image recording apparatus according to claim 1, wherein said display unit and said signal processing unit are disposed in said first housing and said recording unit is disposed in said second housing.

3. An image recording apparatus according to claim 1, wherein said display unit and said recording unit are disposed in said first housing and said signal processing unit is disposed in said second housing.

4. An image pickup apparatus comprising:
a camera unit for picking up an image of an object;
a signal processing unit for processing an image signal output from said camera unit;
a recording unit for recording data by heating a recording medium;
a display unit for displaying the image signal; and
a connection unit for rotatively connecting a first housing and a second housing,
wherein said signal processing unit and said recording unit are disposed in different housings.

5. An image pickup apparatus according to claim 4, wherein said display unit and said signal processing unit are disposed in said first housing and said camera unit and said recording unit are disposed in said second housing.

6. An image pickup apparatus according to claim 4, wherein said display unit and said recording unit are disposed in said first housing and said camera unit and said signal processing unit are disposed in said second housing.
